(19) United States
(12) Patent Application Publication
(10) Pub. No.: US 2019/0394143 A1
(43) Pub. Date: Dec. 26, 2019

(54) FORWARDING DATA BASED ON DATA PATTERNS

(71) Applicant: HEWLETT PACKARD ENTERPRISE DEVELOPMENT LP, Houston, TX (US)

(72) Inventors: Sunitha Ayyappan, Bangalore, Karnataka (IN); Praveen Ramesh Ganjam, Bangalore, Karnataka (IN); Yashavantha Nagaraju, Bangalore, Karnataka (IN)

(21) Appl. No.: 16/013,570

(22) Filed: Jun. 20, 2018

(51) Int. Cl. H04L 12/947; H04L 12/46; H04L 12/26; H04L 12/24

(52) U.S. Cl. CPC H04L 49/25; H04L 41/0893; H04L 43/028; H04L 12/4633

(57) ABSTRACT

In some examples, a system determines whether data of a device that communicates with a switch is to be subjected to further inspection based on a data pattern derived based on the data. In response to determining that the data of the device is not to be subjected to the further inspection, the system causes forwarding, based on forwarding information accessible by the switch, of the data along a path to a recipient. In response to determining that the data of the device is to be subjected to the further inspection, the system causes forwarding of the data by the switch to a controller that applies the further inspection.

### BACKGROUND

A network includes switches that are used to route data communicated between devices. The data is originated by a sender device. The switch receives the data from the sender device, and forwards the received data to a recipient device.

### BRIEF DESCRIPTION OF THE DRAWINGS

Some implementations of the present disclosure are described with respect to the following figures.

FIG. 1 is a block diagram of an arrangement that includes client devices, a switch, controllers, and a policy manager, according to some examples.

FIG. 2 is a flow diagram of a process according to some examples.

FIG. 3 is a block diagram of a system according to some examples.

FIG. 4 is a block diagram of a storage medium storing machine-readable instructions, according to some examples.

FIG. 5 is a flow diagram of a process according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A switch can refer to a network device within a network that forwards data received from a sender device toward a recipient device (or multiple recipient devices). In some examples, a switch includes a layer 2 switch that forwards data packets (also referred to as data frames or data units) based on layer 2 addresses in the data packets. Examples of layer 2 addresses include Medium Access Control (MAC) addresses. In alternative examples, a switch includes a layer 3 router that forwards data packets based on layer 3 addresses, such as Internet Protocol (IP) addresses in the data packets.

As used here, “forwarding” data by a switch refers to the switch using information of the data to decide a path over which the data is to be transmitted. The term “forwarding” can be interchangeably used with the term “routing.”

A switch forwards data (in data packets) between a sender device and a recipient device (or multiple recipient devices) based on forwarding information (or equivalently, “routing information”) accessible by the switch. The forwarding information can include entries that map network addresses (e.g., MAC addresses or IP addresses) and/or ports to respective network paths toward the recipient device(s). A network path to which an entry of forwarding information can direct data received by a switch can include a port of the switch, or physical link connected to the switch, or a virtual link (e.g., a virtual local area network or VLAN) over which the switch is able to communicate.

A switch can include multiple ports, where a port can refer to an interface of the switch that is connected to a link (wired link or wireless link) within a network. A port can either be a physical port implemented using physical circuitry of the switch, or a logical port defined by machine-readable instructions of the switch.

The switch can connect to respective devices (more specifically, “client devices”) through corresponding port(s) of the switch. A “device” can refer to any electronic device, such as any or some combination of a desktop computer, a notebook computer, a tablet computer, a smartphone, a wearable device (e.g., a smart watch, smart eyeglasses, a head-mounted device, etc.), an Internet-of-Things (IoT) device, a vehicle, a household appliance, a game appliance, and so forth. A “client device” refers to a device that is able to make use of a service of another entity, such as a controller or another entity.

In some cases, it may be desired to apply further inspection of data that is to be routed by a switch. Because a switch may not have sufficient processing capacity to perform the further inspection in a timely or efficient manner, data can be sent by the switch to a controller (separate from the switch) to apply the further inspection. The further inspection can include a deep packet inspection (DPI) in which a header (or headers) of a data packet is removed so that the content of the data packet can be inspected in accordance with a policy or rule. For example, the DPI can be performed as part of an operation of a firewall that protects against unauthorized access of a network, policy enforcement to ensure that the data packet conforms to a policy, malware detection to determine if the data packet is related to a malware attack, and so forth. As used here, “further inspection” of data refers to an inspection of data other than accessing a network address and/or port information of the data for the purpose of forwarding the data by the switch based on forwarding information.

To send data from the switch to a controller for further inspection, the switch can send the data through a tunnel to the controller, which then applies the further inspection on the data. After the further inspection (and assuming that the data complies with a respective policy or rule), the controller can forward the data toward a recipient device(s).

In some cases, it is possible to determine whether data is to be tunneled to a controller for further inspection on a per-device basis (also referred to as a “per-user basis”). Data for the given device can be processed in a non-tunneled mode (in which the data is locally switched by the switch based on routing information) or in a tunneled mode (in which the data is tunneled to a controller for further inspection, such as DPI). Whether or not the data for the given device is to be processed in the non-tunneled mode or tunneled mode can be based on an indicator set by a management entity (which can be referred to as a “profile manager” in the ensuing discussion). For example, the indicator can be in the form of a user-role attribute that is settable to different values by the profile manager to indicate whether data for the given device is to be processed in the non-tunneled mode or tunneled mode.

In some examples, once the indicator (e.g., a user-role attribute) is set to a value indicating one of the non-tunneled mode or tunneled mode, the switch remains statically set at the corresponding indicated mode for the given device. Thus, once set to the non-tunneled mode or tunneled mode for the given device, the switch continues to operate in the set non-tunneled mode or tunneled mode regardless of whether or not the data communicated by the given device indicates that a different mode should be used.

In accordance with some implementations of the present disclosure, for a given device, a switch can be dynamically settable to operate in the non-tunneled mode or tunneled mode based on whether or not a data pattern of data of the given device violates a criterion. A “criterion” can refer to any or some combination of the following: a policy, a rule, information representing a condition, and so forth. Note that the term “criterion” can refer to one criterion, or multiple criteria.

A “data pattern” can refer to any characteristic or combination of characteristics relating to data that is communicated between entities. Examples of characteristics include any or combination of the following: a data rate (or a variability of the data rate) at which data is transmitted or received, a size of data (e.g., packet size) (or a variability of the data size) transmitted or received, a burstiness of data (or a variability of the burstiness) transmitted or received, a type of data transmitted or received, and so forth. A variability of a characteristic of data being communicated refers to how much the characteristic varies from a mean characteristic, for example.

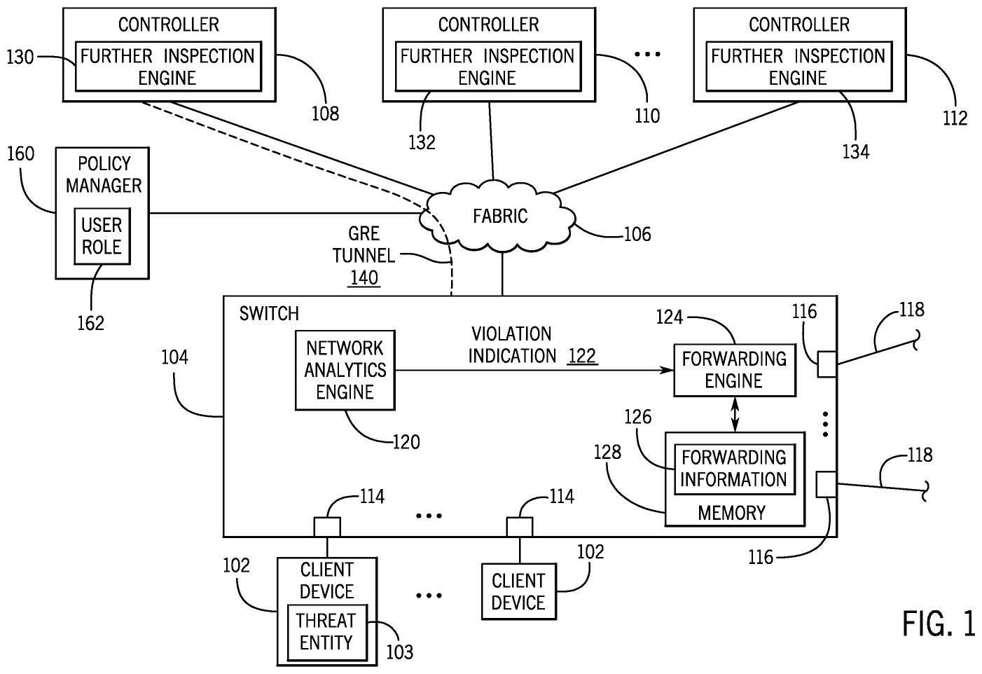

FIG. 1 is a block diagram of an example arrangement that includes various client devices 102 connected to a switch 104. Although just one switch is illustrated in FIG. 1, it is noted that there can be multiple switches connected to respective client devices. The switch(es) is (are) part of a network.

The switch 104 is connected over a communication fabric 106. Various controllers 108, 110, and 112 are also connected to the communication fabric 106. Although a specific number of controllers is depicted in FIG. 1, it is noted that in other examples, a different number of controllers (one controller or more than one controller) can be used.

A communication fabric includes communication links and communication nodes (such as switches, routers, etc.) over which communication between entities can be performed. A “controller” refers to a computing platform, including a computer or multiple computers.

The switch 104 includes various ports to allow connection to entities outside the switch 104. For example, client devices 102 are connected to respective ports 114 of the switch 104. It is noted that a port 114 can be connected to one client device, or can be connected to multiple client devices.

The switch 104 further includes ports 116 that are connected over network links 118 to other entities, such as any or some combination of the following: another client device, another switch, or some other entity.

In some examples, a network analytics engine 120 is provided to analyze data of each of the client devices 102. As used here, the term “engine” can refer to a hardware processing circuit, such as any or some combination of the following: a microprocessor, a core of a multi-core microprocessor, a microcontroller, a programmable integrated circuit device, a programmable gate array, or any other hardware processing circuit. Alternatively, an “engine” can refer to a combination of a hardware processing circuit and machine-readable instructions (software and/or firmware) executable on the hardware processing circuit.

In some examples, the network analytics engine 120 can be part of the switch 104. In other examples, the network analytics engine 120 can be separate from the switch 104, but in communication with the switch 104.

The network analytics engine 120 analyzes data of a client device 102 to detect a data pattern of the data. For example, the data pattern can include a data rate of data that is transmitted by a client device 102 or received by a client device 102. Determining a data rate of data can include calculating a quantity of data communicated in a specified time duration. The data pattern can also include a variability of the data rate, which refers to how much the data rate varies from a mean data rate, for example. In other examples, the data pattern can include other characteristics of data communicated (transmitted or received) by a client device 102.

In an example, the networks analytics engine 120 can determine whether or not the data pattern violates a criterion based on whether or not a data rate or a variability of the data rate violates a threshold (i.e., exceeds or falls below the threshold). In further examples, other characteristic(s) of communicated data can be compared to a respective criterion, such as to determine whether the other characteristic(s) of the data pattern violates a threshold.

In response to determining that the data pattern of a given client device 102 violates the criterion, the network analytics engine 120 provides a violation indication 122 to a forwarding engine 124 of the switch 104. The violation indication 122 indicates that the data pattern of the data of the given client device 102 violates the criterion. The violation indication 122 can be in the form of a message, a signal, an information element, or any other type of indicator.

In response to the violation indication 122, the forwarding engine 124 can cause data of the given client device 102 to be forwarded to a respective controller (one of controllers 108, 110, and 112) for further inspection.

If the forwarding engine 124 does not receive a violation indication for the data of the given client device 102, then the forwarding engine 124 can perform forwarding of the data of the given client device 102 based on local switching at the switch 104. Local switching of data at the switch 104 refers to using forwarding information 126 stored in a memory 128 to determine a path over which data received by the switch 104 is to be transmitted. The forwarding information 126 provides information regarding how data is to be forwarded by the forwarding engine 124. For example, the forwarding information 126 can include multiple entries, where each entry correlates a network address and/or a port to a corresponding output path. For example, a network address can include a MAC address or an IP address included in a data packet. A port can include the port (114 or 116) of the switch 104 at which the data packet was received.

The output path mapped by an entry of the forwarding information 126 can include a port of the switch 104 through which the data packet is to be transmitted. In other examples, other indications of output paths can be used, including network addresses, VLAN identifiers, and so forth.

The memory 128 can be implemented using a memory device (or multiple memory devices) or a storage device (or multiple storage devices). The memory 128 can be part of the switch 104, or can be external of the switch 104 but accessible by the switch 104.

Each of the controllers 108, 110, and 112 includes a respective further inspection engine 130, 132, and 134. Each further inspection engine can apply a respective further inspection, such as a DPI, on data.

In some examples, from the perspective of the switch 104, one of the controllers 108, 110, and 112 can be a primary controller to which data is to be forwarded by the switch 104 for further inspection. Another of the controllers 108, 110, and 112 can be a standby controller to be used in case of failure or fault of the primary controller. Yet another of the controllers 108, 110, and 112 can be a load balancing controller that is to be used for balancing workload in case the primary controller becomes overloaded. For example, if the primary controller is sent a large amount of data for further inspection, load balancing can be performed to distribute data across multiple controllers (including the primary controller and the load balancing controller) to apply the further inspection.

In other examples, the use of a standby controller and/or load balancing controller can be omitted.

For data of a respective client device 102, the switch 104 operates in the non-tunneled mode to perform local switching of the data of the respective client device 102. On the other hand, the switch 104 operates in the tunneled mode to forward the data of the respective client device 102 to a controller (108, 110, or 112) for further inspection.

Note that for multiple client devices 102, the switch 104 can operate in the tunneled mode for a first client device 102 based on the data pattern of the first client device 102, but can operate in the non-tunneled mode for a second client device 102 based on the data pattern of the second client device 102.

In the tunneled mode, the forwarding engine 124 sends the data of the respective client device 102 through a tunnel 140 from the switch 104 to a corresponding controller (e.g., the controller 108) for further inspection of the data by the further inspection engine 130 of the controller 108. In some examples, the tunnel 140 can be a Generic Routing Encapsulation (GRE) tunnel. GRE is a tunneling protocol that encapsulates data for delivery to a target entity, which in this case is a controller. GRE encapsulates a data packet using a GRE header. Once the further inspection engine 130 receives a GRE encapsulated data packet from the switch 104, the further inspection engine 130 can apply decapsulation to remove the GRE header, and to perform further inspection on the content of the decapsulated data packet.

In other examples, instead of using a GRE tunnel, data can be communicated between the switch 104 and a controller using a tunnel according to another tunneling protocol.

Based on the further inspection applied by the further inspection engine 130, the controller 108 can decide whether or not to send the data packet to the intended destination of the data packet. If the further inspection determines that the data packet is associated with a security threat or is associated with another condition indicating that the data packet should not be forwarded to the destination, the controller 108 can block further transmission of the data packet. For example, the security threat or other condition can be caused by a threat entity 103 associated with the given client device 102. The threat entity 103 can include malware, an unauthorized user, and so forth.

The controller 108 can take action to address the security threat or other condition related to the data packet, such as by notifying a security manager or other entity to take action. The action taken by the controller 108 or the other entity can include blocking further access by the given client device 102 of a network, running a malware cleaning tool on the given client device 102 to remove or quarantine malware, or shutting down the given client device 102, blocking user access of the given client device 102, or other action.

To set the switch 104 in the tunneled mode or non-tunneled mode with respect to data of the given client device 102, the switch 104 can interact with a policy manager 160 that is coupled to the communication fabric 106. The policy manager 160 can be implemented as a computing node (including a computer or multiple computers). In some cases the policy manager 160 can be part of any one or some combination of the controllers 108, 110, and 112. Alternatively, the policy manager 160 is separate from the controllers 108, 110, and 112.

In some examples, the policy manager 160 can provide role-based or device-based secured access control for the client devices 102. A device-based secured access control can refer to allowing or disallowing access of a client device 102 on a per client device basis (i.e., one client device may be allowed access to a network or a service while another client device is not allowed access to a network or service). A role-based secure access control can refer to allowing or disallowing access of a network or service based on a role assigned to a client device or a user of a client device.

One example type of role-based secure access control that can be provided by the policy manager 160 is the setting of the use of the tunneled mode or non-tunneled mode for data of a respective client device 102. In some examples, the policy manager 160 is able to assign a user role 162 to the data of the respective client device 102. The user role 162 if set to a first value (“tunneled mode value”) indicates that the switch 104 is to operate in the tunneled mode for the respective client device 102. On the other hand, the user role 162 if set to a different second value (“non-tunneled mode value”) indicates that the switch 104 is to operate in the non-tunneled mode for the data of the respective client device 102.

The switch 104 operating in the tunneled mode or non-tunneled mode for the respective client device 102 can refer to the switch 104 operating in the tunneled mode or non-tunneled mode for all data of the respective client device 102 or for a subset of data (e.g., voice-over-IP data, web browsing data, email data, etc.) of the respective client device 102.

The policy manager 160 can assign different user roles 162 for corresponding different client devices 102. Generally, a user role can refer to an attribute settable to multiple values for indicating different roles for a respective client device 102, where in some examples the different roles can include a first role corresponding to the tunneled mode, and a second role corresponding to the non-tunneled mode.

More generally, the control of whether to operate the switch 104 in the tunneled mode or the non-tunneled mode can be performed by a system. The “system” can refer to a computing node or an arrangement of computing nodes. As discussed above, the system can include the switch 104, or the switch 104 interacting with the policy manager 160. In other examples, the system can include the policy manager 160 or another entity that obtains information of a data pattern of data received by a switch from a client device, determines whether the data pattern violates a criterion, and in response to the determining, dynamically selects between the tunneled mode of the switch and the non-tunneled mode of the switch.

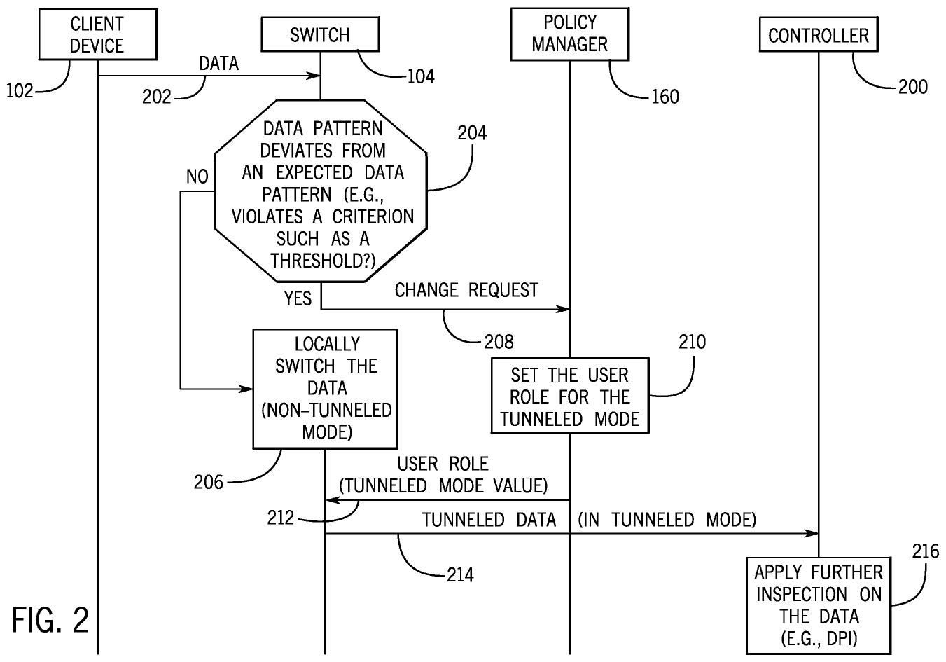

FIG. 2 is a flow diagram of a process that involves a client device 102, the switch 104, a controller 200 (which can be any of the controllers 108, 110, and 112 of FIG. 1), and the policy manager 160.

The client device 102 sends (at 202) data to the switch 104 for forwarding to a destination.

The switch 102 uses (at 204) the network analytics engine 120 (FIG. 1) to analyze data of the client device 102 for determining (at 206) whether a data pattern of the data received (at 202) from the client device deviates from an expected data pattern (e.g., the data pattern violates a criterion). If the data pattern does not violate the criterion, then the switch 104 continues to operate in the non-tunneled mode for the client device 102 (assuming that the switch 104 is initially operating in the non-tunneled mode for the client device 102), and locally switches (at 206) the data using the forwarding information (126 in FIG. 1) accessible by the switch 104. The locally switched data is forwarded by the switch 104 to a path in a network for communication to the destination.

However, if the data pattern violates the criterion, then the switch 104 sends (at 208) a change request to the policy manager 160, where the change request is to cause a change a role of the switch 104 from the non-tunneled mode to the tunneled mode for the client device 102. In some examples, the change request can be referred to as a change of authorization request. In response to the change request, the policy manager 116 sets (at 210) the user role 162 for the client device 102 to the tunneled mode value to indicate operation in the tunneled mode for the client device 102.

The user role set to the tunneled mode value is sent (at 212) by the policy manager 160 to the switch 104. The user role set to the tunneled mode value is an example of an indicator, provided by the policy manager 160, that the tunneled mode of the switch is to be used.

In some examples, a benefit of interacting with the policy manager 160 to dynamically select operation of the switch 104 in the tunneled mode or the non-tunneled mode is to allow for leveraging a mechanism or technique provided by the policy manager 160 for controlling the operation of the switch 104. The mechanism or technique provided by the policy manager 160 that is used is the role-based control of operation of the switch 104. As a result, a separate management system for controlling the tunneled/non-tunneled mode of operation of the switch 104 does not have to be provided.

In other examples, the switch 104 does not interact with the policy manager 160 for controlling the tunneled/non-tunneled mode of operation of the switch 104. Rather, the switch 104 can interact with a different system to perform the control of tunneled versus non-tunneled mode, or can perform the control itself. As yet another example, the control of whether the switch 104 operates in the tunneled or non-tunneled mode is by a system separate from the switch 104, such as the policy manager 160 or another entity.

In response to the user role set to the tunneled mode value, the switch 104 operates in the tunneled mode to send (at 214) data to the controller 200 through a tunnel. The controller 200 then applies (at 216) further inspection on the data that is tunneled from the switch 104 to the controller 200.

Although not shown in FIG. 2, it is noted that in some cases, the data of the network analytics engine 120 can detect that the data pattern of the data of the client device 102 has changed so that it no longer violates the criterion, in which case the switch 104 can initiate another change request with the policy manager 160 to change the user role to a different value for indicating non-tunnel mode for data of the client device 102.

The ability to selectively operate a switch in the tunneled mode or non-tunneled mode according to some implementations of the present disclosure can allow for various benefits. For example, tunnel congestion between a switch and a controller can be reduced, by reducing the amount of traffic for respective client devices that is tunneled to the controller in the tunneled mode. As another example, the load placed on the controller can be reduced since the amount of traffic sent to the controller for further inspection can be reduced by operating the switch in non-tunneled mode for certain client devices. Reducing the load on the controller allows for faster operation of the controller. Moreover, by reducing the load associated with further inspection of data, the number of controllers that have to be deployed in a network can be reduced, to reduce equipment costs.

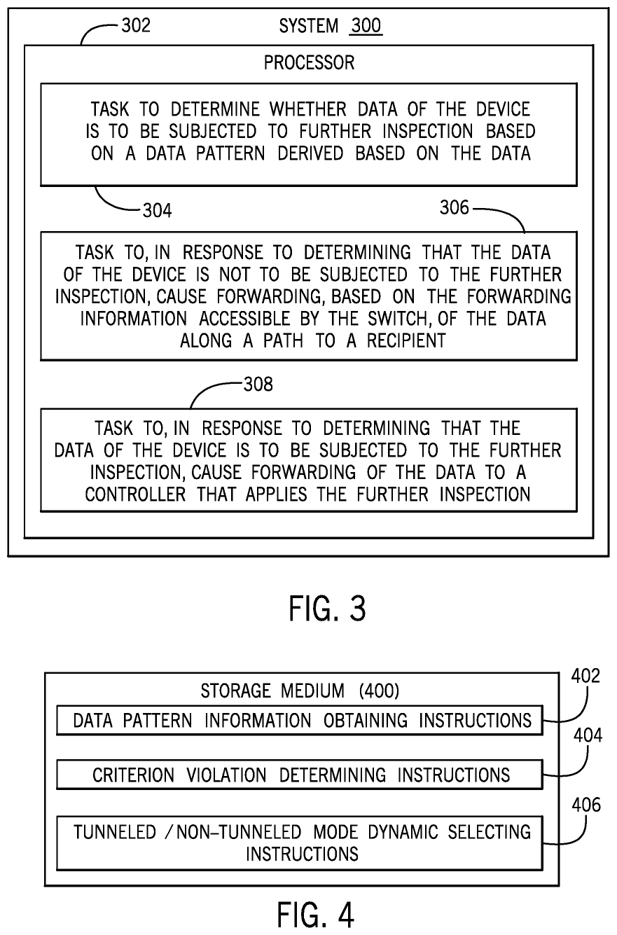

FIG. 3 is a block diagram of a system 300 for controlling a mode of operation of a switch that communicates with a device (e.g., a client device 102 of FIG. 1). The system 300 includes a processor 302 to perform various tasks. A processor can include a microprocessor, a core of a multi-core microprocessor, a microcontroller, a programmable integrated circuit, a programmable gate array, or another hardware processing circuit.

A processor performing a task can refer to a single processor performing the task or multiple processors performing the task (using a hardware processing circuit of the processor or machine-readable instructions executable on the processor).

The system 300 can include the switch 104 or a different entity.

The tasks include a task 306 to determine whether data of the device is to be subjected to further inspection based on a data pattern derived based on the data. The determining includes determining whether the data pattern obtained by the switch deviates from an expected data pattern (such as whether the data pattern violates a criterion).

The tasks include a task 308 to, in response to determining that the data of the device is not to be subjected to the further inspection, cause forwarding, based on routing information accessible by the switch, of the data along a path to a recipient.

The tasks further include a task 310 to, in response to determining that the data of the device is to be subjected to the further inspection, cause forwarding by the switch of the data to a controller that applies the further inspection.

In examples where the system 300 is the switch 104, then the tasks 308 and 310 are tasks of the switch 104 for forwarding data based on local switching or tunneling, respectively. In other examples where the system 300 is an entity separate from the switch 104, then the tasks 308 and 310 are tasks of the separate entity, and the causing of the forwarding of data according to the tasks 308 and 310 includes instructions provided by the entity to the switch 104.

FIG. 4 is a block diagram of a non-transitory machine-readable or computer-readable storage medium 400 storing machine-readable instructions that upon execution cause a system to perform various tasks.

The machine-readable instructions include data pattern information obtaining instructions 402 to obtain information of a data pattern of data received by a switch from a device. The machine-readable instructions include criterion violating determining instructions 404 to determine whether the data pattern violates a criterion. The machine-readable instructions include tunneled/non-tunneled mode dynamic selecting instructions 406 to, in response to the determining, dynamically select between a tunneled mode of the switch and a non-tunneled mode of the switch, wherein in the tunneled mode the switch forwards the data through a tunnel to a controller for further inspection of the data by the controller, and wherein in the non-tunneled mode the switch forwards the data by locally switching the data using forwarding information at the switch.

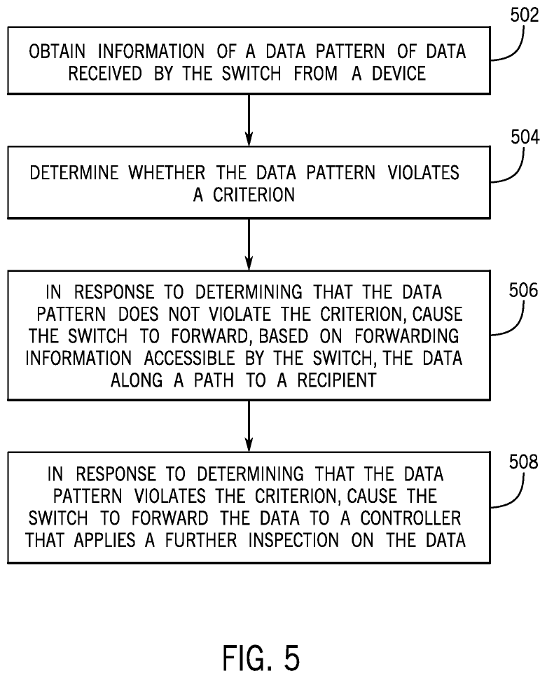

FIG. 5 is a flow diagram of a process of a system, such as the switch 104 of FIG. 1 or a different entity.

The system obtains (at 502) information of a data pattern of data received by the switch from a device.

The system determines (at 504) whether the data pattern violates a criterion.

In response to determining that the data pattern does not violate the criterion, the system causes the switch to forward (at 506), based on forwarding information accessible by the switch, the data along a path to a recipient.

In response to determining that the data pattern violates the criterion, the system causes the switch to forward (at 508) the data to a controller that applies a further inspection on the data.

The storage medium 400 of FIG. 4 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
a processor to:
determine whether data of a device in communication with a switch is to be subjected to further inspection based on a data pattern derived based on the data,
in response to determining that the data of the device is not to be subjected to the further inspection, cause forwarding, based on forwarding information accessible by the switch, of the data along a path to a recipient, and
in response to determining that the data of the device is to be subjected to the further inspection, cause forwarding of the data by the switch to a controller that applies the further inspection.

2. The system of claim 1, wherein the processor is to perform the determining by determining whether the data pattern deviates from an expected data pattern.

3. The system of claim 1, wherein the processor is to perform the determining by determining whether the data pattern violates a criterion.

4. The system of claim 1, wherein the forwarding of the data based on the forwarding information comprises locally switching the data in a non-tunneled mode of the switch.

5. The system of claim 4, wherein the forwarding of the data to the controller that applies the further inspection comprises forwarding the data to the controller through a tunnel in a tunneled mode of the switch.

6. The system of claim 5, wherein the device is assigned a user role settable to a first value indicating the tunneled mode, and to a second value indicating the non-tunneled mode, and wherein the processor is to selectively use the tunneled mode or the non-tunneled mode responsive to whether the user role is respectively set to the first value or the second value.

7. The system of claim 6, wherein the processor is to interact with a policy manager that dynamically sets the user role to the first value or the second value.

8. The system of claim 7, wherein the processor is to:
in response to determining that the data of the device is to be subjected to the further inspection:
send a request to the policy manager to change a value of the user role, and
receive a change in value of the user role from the policy manager, in response to the request.

9. The system of claim 5, wherein the tunnel comprises a Generic Routing Encapsulation (GRE) tunnel.

10. The system of claim 1, wherein the further inspection comprises a deep packet inspection, by the controller, of packets in the data.

11. A non-transitory machine-readable storage medium storing instructions that upon execution cause a system to:
obtain information of a data pattern of data received by the switch from a device;
determine whether the data pattern violates a criterion; and
in response to the determining, dynamically select between a tunneled mode of the switch and a non-tunneled mode of the switch, wherein in the tunneled mode the switch forwards the data through a tunnel to a controller for further inspection of the data by the controller, and wherein in the non-tunneled mode the switch forwards the data by locally switching the data using forwarding information at the switch.

12. The non-transitory machine-readable storage medium of claim 11, wherein the data pattern violating the criterion comprises the data pattern comprising a characteristic of the data pattern violating a specified threshold.

13. The non-transitory machine-readable storage medium of claim 12, wherein the data pattern comprises a variability in a data rate of the data between the device and the switch.

14. The non-transitory machine-readable storage medium of claim 11, wherein the instructions upon execution cause the system to:
in response to determining the data pattern does not violate the criterion, operate the switch in the non-tunneled mode.

15. The non-transitory machine-readable storage medium of claim 11, wherein the instructions upon execution cause the system to:
in response to determining the data pattern violates the criterion, interact with a policy manager to cause selection of the tunneled mode of the switch.

16. The non-transitory machine-readable storage medium of claim 15, wherein the interacting with the policy manager comprises:
sending, by the switch, a request to the policy manager to change a mode of operation of the switch; and
receiving, by the switch from the policy manager in response to the request, an indicator that the tunneled mode of the switch is to be used.

17. The non-transitory machine-readable storage medium of claim 11, wherein the data pattern violating the criterion indicates that a threat entity is associated with the device.

18. A method comprising:
obtaining, by a system comprising a processor, information of a data pattern of data received by the switch from a device;
determining, by the system, whether the data pattern violates a criterion;
in response to determining that the data pattern does not violate the criterion, forwarding, by the switch based on forwarding information accessible by the switch, the data along a path to a recipient, and
in response to determining that the data pattern violates the criterion, forwarding, by the system, the data to a controller that applies a further inspection on the data.

19. The method of claim 18, further comprising:
in response to determining that the data pattern does not violate the criterion, operating the switch in a non-tunneled mode that forwards the data based on the forwarding information.

20. The method of claim 19, further comprising:
in response to determining that the data pattern violates the criterion, operating the switch in a tunneled mode that sends the data, in a tunnel, to the controller that applies the further inspection on the data.
